(19) United States
(12) Patent Application Publication
(10) Pub. No.: US 2023/0282924 A1
(43) Pub. Date: Sep. 7, 2023

(54) INTUMESCENT INORGANIC COMPOSITES FOR MITIGATING A THERMAL RUNAWAY EVENT IN A BATTERY

(71) Applicant: GM GLOBAL TECHNOLOGICAL OPERATIONS LLC, Detroit, MI (US)

(72) Inventors: Xingcheng Xiao, Troy, MI (US); Yangbing Zeng, Troy, MI (US); Su Jung Han, West Bloomfield, MI (US); James R. Salvador, East Lansing, MI (US)

(73) Assignee: GM GLOBAL TECHNOLOGY OPERATIONS LLC, Detroit, MI (US)

(21) Appl. No.: 17/683,785

(22) Filed: Mar. 1, 2022

(51) Int. Cl. H01M 50/293; H01M 10/658; H01M 50/588; H01M 50/502; H01M 50/593

(52) U.S. Cl. CPC H01M 50/293; H01M 10/658; H01M 50/588; H01M 50/502; H01M 50/593

(57) ABSTRACT

A battery cell thermal insulator configured for mitigating a thermal event in a battery is provided. The battery cell thermal insulator includes a metal plate configured for providing rigidity to the battery cell thermal insulator. The battery cell thermal insulator further includes a layer of inorganic intumescent composite material disposed upon one side of the metal plate configured for providing thermal resistivity.

### INTRODUCTION

The disclosure generally relates to intumescent inorganic composites for mitigating a thermal event inside a battery, a battery pack, and/or in battery modules.

A device may include a battery or battery system useful for providing electrical power to the device. In one example, a vehicle may include a battery system useful for providing electrical power to vehicle systems, such as a motor generator unit that provides a torque to an output shaft for motive force to the vehicle and auxiliary systems useful for controlling the vehicle, providing information to the occupants of the vehicle, and other useful functions.

### SUMMARY

A battery cell thermal insulator configured for mitigating a thermal event in a battery is provided. The battery cell thermal insulator includes a metal plate configured for providing rigidity to the battery cell thermal insulator. The battery cell thermal insulator further includes a layer of inorganic intumescent composite material disposed upon one side of the metal plate configured for providing thermal resistivity.

In some embodiments, the metal plate includes an aluminum sheet.

In some embodiments, the metal plate includes a steel sheet.

In some embodiments, the layer of inorganic intumescent composite material includes an inorganic thermal retardant selected from the group consisting of boehmite, MgCo₃, KNO₃, (NH₄)₃Po₄, and combinations thereof.

In some embodiments, the layer of inorganic intumescent composite material includes an inorganic binder material selected from the group consisting of a geopolymer material and a water glass material.

In some embodiments, the battery cell thermal insulator further includes a thermal insulating foam disposed between and in contact with the metal plate and the layer of inorganic intumescent composite material.

According to one alternative embodiment, a battery cell thermal insulator configured for mitigating a thermal event in a battery is provided. The battery cell thermal insulator includes a plurality of metal plates each configured for providing rigidity to the battery cell thermal insulator. Each of the plurality of metal plates is arranged parallel to another one of the plurality of metal plates. The battery cell thermal insulator further includes at least one layer of thermal insulating foam disposed between and in contact with two of the plurality of metal plates. The battery cell thermal insulator further includes a layer of inorganic intumescent composite material disposed upon one side of an outermost one of the plurality of metal plates. The layer of inorganic intumescent composite material is exposed on an outer surface of the battery cell thermal insulator and is configured for providing thermal resistivity.

In some embodiments, the battery cell thermal insulator further includes a second layer of inorganic intumescent composite material disposed upon one side of a second outermost one of the plurality of metal plates. The layer of inorganic intumescent composite material is exposed on a second outer surface of the battery cell thermal insulator.

In some embodiments, each of the plurality of metal plates is an aluminum sheet.

In some embodiments, each of the plurality of metal plates is a steel sheet.

In some embodiments, the layer of inorganic intumescent composite material includes an inorganic binder material.

In some embodiments, the inorganic binder material is selected from the group consisting of a geopolymer material and a water glass material.

In some embodiments, the battery cell thermal insulator further includes a layer of polyester film disposed between and in contact with the layer of inorganic intumescent material and the outermost one of the plurality of metal plates.

According to one alternative embodiment, a battery system is provided. The battery system includes a first battery cell, a second battery cell, and a battery cell thermal insulator configured for mitigating a thermal event in the battery system. The battery cell thermal insulator is disposed between the first battery cell and the second battery cell. The battery cell thermal insulator includes at least one metal plate configured for providing rigidity to the battery cell thermal insulator and a first layer of inorganic intumescent composite material disposed upon one side of the battery cell thermal insulator and configured for providing thermal resistivity. The battery cell thermal insulator further includes a second layer of inorganic intumescent composite material disposed upon a second side of the battery cell thermal insulator and configured for providing thermal resistivity.

In some embodiments, the battery system further includes a bus bar disposed adjacent to and in contact with the first battery cell and a third layer of inorganic intumescent composite material disposed on the bus bar. The third layer of inorganic intumescent composite material is configured for preventing arcing between the first battery cell and the bus bar during the thermal event.

In some embodiments, the battery cell thermal insulator further includes a plurality of metal plates each arranged parallel to one another and a layer of thermal insulating foam disposed between and in contact with two of the plurality of metal plates.

In some embodiments, the battery system further includes a third battery cell and a second battery cell thermal insulator disposed between and in contact with the second battery cell and the third battery cell.

In some embodiments, the at least one metal plate is an aluminum sheet.

In some embodiments, the at least one metal plate is a steel sheet.

In some embodiments, the first layer of inorganic intumescent composite material includes an inorganic binder material.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates a battery system including a plurality of battery cells, wherein each of the plurality of battery cells is separated from a neighboring another one of the plurality of battery cells by a battery cell thermal insulator, in accordance with the present disclosure;

FIG. 2 schematically illustrates in cross-section the battery cell thermal insulator of FIG. 1, in accordance with the present disclosure;

FIG. 3 is a graph illustrating decomposition and endo-/exo-thermal behavior at different temperatures of various materials that may be used to coat an outer surface of the battery cell thermal insulator of FIG. 1, in accordance with the present disclosure;

FIG. 4 is a graph illustrating thermal diffusivity of a battery cell thermal insulator of FIG. 1 coated with an inorganic intumescent composite (IIC) material versus a battery cell thermal insulator that is uncoated, in accordance with the present disclosure;

FIG. 5 is a graph illustrating thermal conductivity of a battery cell thermal insulator of FIG. 1 coated with an IIC material versus a battery cell thermal insulator that is uncoated, in accordance with the present disclosure; and

FIG. 6 schematically illustrates a battery cell thermal insulator, which includes a coating including an IIC material on one side of the thermal insulator, in accordance with the present disclosure.

### DETAILED DESCRIPTION

A battery electric vehicle includes a battery system useful for providing electrical power to the vehicle. A battery system may include one or more battery cells, each battery cell including an anode, a cathode, a separator, and an electrolyte solution. Under typical operation, in a discharging cycle, electrical energy is provided by each of the battery cells through an electrochemical reaction between the anode and the cathode, facilitated by ion transfer through the electrolyte and the separator. In a corresponding charging cycle, electrical energy is provided to one or more of the battery cells, and the electrochemical reaction is operated in reverse to store energy within each of the battery cells.

The anode and the cathode each include chemicals selected to react with each other to drive the electrochemical reaction. The anode and the cathode are kept separated from each other by the separator. If somehow the anode and the cathode are caused to touch each other or if a bridge of electrically conductive material forms between the anode and the cathode, an internal short circuit condition may be created. When such an internal short circuit is created, the electrochemical reaction between the anode and the cathode may occur rapidly. Such a rapid electrochemical reaction may cause the temperature of the battery cell to rise. Such a rise in temperature of the battery cell may be described as a thermal event. In one embodiment, a temperature of a battery cell during a thermal evert may rise to 1,000° C.

A battery system may include a plurality of battery cells arranged next to each other. One side of a first battery cell may be arranged next to or in contact with one side of a second battery cell. Under typical operation, such side-by-side arrangement of the battery cells may have several beneficial effects. For example, weight and package size of components within a battery electric vehicle are design considerations or constraints, for example, impacting a driving range of the battery electric vehicle. During a thermal event, heat generated by a rise in temperature in a first battery cell may be transferred to a neighboring battery cell or battery cells. The rise in temperature in the first battery cell may spread or cascade through the neighboring battery cells, and then into other battery cells of the battery system. A battery cell thermal insulator may be useful if disposed between two battery cells to prevent or limit heat transfer between the battery cells.

An inorganic intumescent composite (IIC) including inorganic chemical components configured for preventing heat transfer is provided. An intumescent material is one that thickens or expands when exposed to high temperature. The IIC may be used to coat a battery cell thermal insulator and limit heat transfer through the battery cell thermal insulator. An inorganic binder may be used to maintain shape and adhesion of the IIC to the battery cell thermal insulator. In one embodiment, a geopolymer and/or water glass may be utilized as the main binder and intumescent forming agent, combining inorganic combustion resistance and highly porous materials. A geopolymer may be described as an amorphous aluminosilicate. A geopolymer may alternatively be described as inorganic, typically ceramic, alumino-silicate forming long-range, covalently bonded, non-crystalline (amorphous) networks. A water glass is a compound containing sodium oxide (Na₂O) and silica (silicon dioxide, SiO₂) that forms a glassy solid with the very useful property of being soluble in water. In one embodiment, the layer of IIC material includes an inorganic thermal retardant selected from the group consisting of boehmite, MgCo₃, KNO₃, (NH₄)₃Po₄, or combinations thereof. In addition to coating battery cell thermal insulators between battery cells of the battery system, the materials described herein may also be used to coat surfaces of other portions of the battery cell, for example, utilizing dielectric properties of the materials to prevent arcing between the battery cell and surrounding equipment, such as a bus bar that may be used to connect battery cell terminals. In one embodiment, the bus bar may be coated with IIC material. In another embodiment, an interior surface of the battery may be coated with IIC material. The IIC materials may be selected to have high dielectric strength, for example, including a breakdown voltage of ˜400 kV/mm (approximately 400 times higher than air) to avoid arcing during the thermal event.

Formation of inorganic silicate based intumescent structure upon a battery cell thermal insulator significantly improves thermal insulating properties and slows down heat transfer between adjacent battery cells. The IIC layers disclosed herein have excellent mechanical strength at high temperatures compared to polymer based intumescent materials. Excellent mechanical strength at high temperatures allows the battery cell thermal insulator to remain intact throughout a thermal event in an adjacent battery cell.

A battery cell thermal insulator including inorganic intumescent composite materials is provided that is useful to limit heat transfer between a first battery cell and a second battery cell of a battery system. In one embodiment, the battery cell thermal insulator includes one or more metal plates. The metal plates may be aluminum, steel, or other similar materials. The metal plates may include aluminum, steel, or other similar materials, their alloys, and may include coatings. Aluminum is advantageous due to its light weight. If exposed directly to high temperatures during a thermal event, an aluminum plate may warp or be rendered unusable, thereby creating a leak path for heat to get past the battery cell thermal insulator. Use of aluminum as one or more layers in the battery cell thermal insulator is enabled by the use of an external layer of the IIC materials coated over the aluminum. The IIC materials provide excellent thermal insulation even prior to expanding due to exposure to high heat. As high temperatures are exposed to the IIC materials, the IIC materials grow or get thicker and provide excellent thermal insulation, protecting the aluminum plate beneath the IIC materials from thermal damage. One or more steel plates may similarly be utilized. Steel is resistant to higher temperatures as compared to aluminum and may withstand the heat of a thermal event, although steel is heavier than aluminum and may be prohibitive to vehicle weight targets.

According to one embodiment, a battery cell thermal insulator configured for mitigating a thermal event in a battery is provided. The battery cell thermal insulator includes a metal plate configured for providing rigidity to the battery cell thermal insulator. The battery cell thermal insulator further includes a layer of inorganic intumescent composite material disposed upon one side of the metal plate and configured for providing thermal resistivity.

The metal plate may include an aluminum sheet.

The metal plate may include a steel sheet.

The layer of inorganic intumescent composite material may include an inorganic thermal retardant selected from the group consisting of boehmite, MgCo₃, KNO₃, (NH₄)₃Po₄, and combinations thereof.

The layer of inorganic intumescent composite material may include an inorganic binder material selected from the group consisting of a geopolymer material and a water glass material.

The battery cell thermal insulator may further include a thermal insulating foam disposed between and in contact with the metal plate and the layer of inorganic intumescent composite material.

According to one embodiment, a battery cell thermal insulator configured for mitigating a thermal event in a battery is provided. The battery cell thermal insulator includes a plurality of metal plates each configured for providing rigidity to the battery cell thermal insulator. Each of the plurality of metal plates is arranged parallel to another one of the plurality of metal plates. The battery cell thermal insulator further includes at least one layer of thermal insulating foam disposed between and in contact with two of the plurality of metal plates. The battery cell thermal insulator further includes a layer of inorganic intumescent composite material disposed upon one side of an outermost one of the plurality of metal plates. The layer of inorganic intumescent composite material is exposed on an outer surface of the battery cell thermal insulator and is configured for providing thermal resistivity.

The battery cell thermal insulator may further include a second layer of inorganic intumescent composite material disposed upon one side of a second outermost one of the plurality of metal plates. The layer of inorganic intumescent composite material may be exposed on a second outer surface of the battery cell thermal insulator.

Each of the plurality of metal plates may be an aluminum sheet.

Each of the plurality of metal plates may be a steel sheet.

The layer of inorganic intumescent composite material may include an inorganic binder material.

The inorganic binder material may be selected from the group consisting of a geopolymer material and a water glass material.

The battery cell thermal insulator may further include a layer of polyester film disposed between and in contact with the layer of inorganic intumescent material and the outermost one of the plurality of metal plates.

According to one embodiment, a battery system is provided. The battery system includes a first battery cell, a second battery cell, and a battery cell thermal insulator configured for mitigating a thermal event in the battery system. The battery cell thermal insulator is disposed between the first battery cell and the second battery cell. The battery cell thermal insulator includes at least one metal plate configured for providing rigidity to the battery cell thermal insulator, a first layer of inorganic intumescent composite material disposed upon one side of the battery cell thermal insulator and configured for providing thermal resistivity, and a second layer of inorganic intumescent composite material disposed upon a second side of the battery cell thermal insulator and configured for providing thermal resistivity.

The battery system of may further include a bus bar disposed adjacent to and in contact with the first battery cell and a third layer of inorganic intumescent composite material disposed on the bus bar and configured for preventing arcing between the first battery cell and the bus bar during the thermal event.

The battery cell thermal insulator may further include a plurality of metal plates each arranged parallel to one another and a layer of thermal insulating foam disposed between and in contact with two of the plurality of metal plates.

The battery system may further include a third battery cell and a second battery cell thermal insulator disposed between and in contact with the second battery cell and the third battery cell.

The at least one metal plate may be an aluminum sheet.

The at least one metal plate may be a steel sheet.

The first layer of inorganic intumescent composite material may include an inorganic binder material.

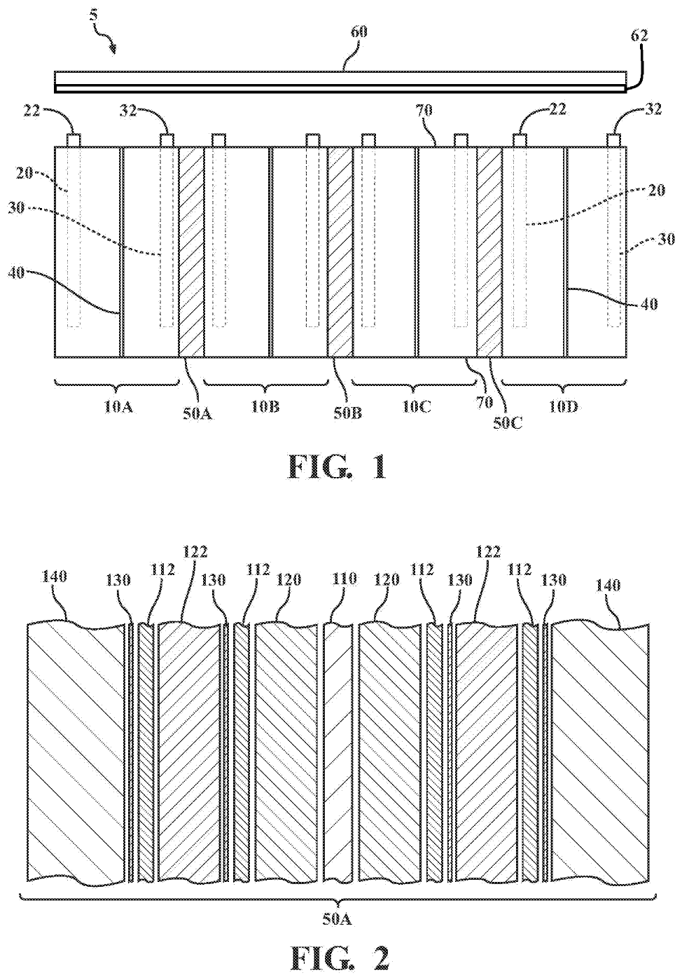

Referring now to the drawings, wherein like reference numbers refer to like features throughout the several views, FIG. 1 schematically illustrates a battery system 5 including a plurality of battery cells 10A, 10B, 10C, and 10D, wherein each of the plurality of battery cells 10A, 10B, 10C, and 10D is separated from a neighboring another one of the plurality of battery cells 10A, 10B, 10C, and 10D with or by a battery cell thermal insulator 50A, 50B, or 50C. The battery cells 10A, 10B, 10C, and 10D each are illustrated including an anode 20, a cathode 30, and a separator 40. An electrolyte solution exists in a space between the anode 20 and the cathode 30. Each anode 20 includes a negative terminal 22 protruding upwardly from the corresponding battery cell 10A, 10B, 10C, or 10D. Each cathode 30 includes a positive terminal 32 projecting upwardly from the corresponding battery cell 10A, 10B, 10C, or 10D. A bus bar 60 is illustrated running along a top side of the battery cells 10A, 10B, 10C, and 10D. A battery casing 70 is illustrated containing the contents of the battery cells 10A, 10B, 10C, and 10D. The battery casing 70 may include polymerized materials.

The illustrated battery cell thermal insulators 50A, 50B, and 50C are useful to prevent or limit heat transfer between the battery cells 10A, 10B, 10C, and 10D in a case of a thermal event in one of the battery cells. For example, if battery cell 10B operates inefficiently and the temperature within the battery cell 10B starts to go up quickly, the battery cell thermal insulator 50A limits heat transfer from the battery cell 10B to the battery cell 10A. Similarly, the battery cell thermal insulator 50B limits heat transfer from the battery cell 10B to the battery cell 10C. In this way, thermal events may be prevented from spreading from one battery cell or group to a next battery cell or group.

Battery casing 70 is further illustrated on a top and bottom of the battery cells 10A, 10B, 10C, and 10D. In one embodiment, the bus bar 60 may include a coating 62 of IIC materials to prevent arcing during a thermal event.

FIG. 2 schematically illustrates in cross-section the battery cell thermal insulator 50A of FIG. 1. Cross-sections of the remaining battery cell thermal insulators 50B and 50C are substantially similar or the same as the illustrated cross section of the battery cell thermal insulator 50A. A relatively thick metal plate 110 and four relatively thin metal plates 112 are illustrated. The metal plates may be constructed with aluminum, steel, or other similar materials. In one embodiment, thicknesses of the aluminum plates may include a thickness of from 200 microns to 300 microns. In another embodiment, thicknesses of the aluminum plates may include a thickness of from 200 microns to 1 millimeter (mm). In another embodiment, a thickness of each steel plate may include 0.254 mm (the relatively thick metal plate 110) and 0.127 mm (the four relatively thin metal plates 112). Additionally, two layers of ATB 1000 Aerogel® 120 and two layers of ATB 2000 Aerogel® 122 are illustrated and may be referred to a thermal insulating foams, which both are commercially available through the Aerogel Technologies, LLC company of Glendale, Wis. The two layers of ATB 1000 Aerogel® 120 are illustrated disposed between and in contact with the relatively thick metal plate 110 and a first two of the relatively thin metal plates 112. The two layers of ATB 2000 Aerogel® 122 are illustrated disposed between and in contact with each of the first two relatively thin metal plates 112 and a corresponding one of the remaining relatively thin metal plates 112. Additionally, four layers of polyester film 130 (PET film) are illustrated disposed next to and in contact with each of the relatively thin metal plates 112. Finally, on either outside surface of the battery cell thermal insulator 50A, two layers of IIC material foam 140 including a geopolymer binder are illustrated. In one embodiment, the two layers of IIC material foam 140 are 0.2 mm thick prior to being exposed to elevated temperatures. The IIC material foam 140 is configured to expand, for example, to a thickness of from 1.5 mm to 2.0 mm after being exposed to high temperatures. The metal plates 110 and 112 provide rigidity. The layers of IIC material foam 140 protect the metal plates 112 from exposure to high temperatures and provide low thermal diffusivity and low thermal conductivity. Providing low thermal diffusivity and/or low thermal conductivity may collectively be described as providing thermal resistivity or excellent thermal resistance The layers of Aerogel® 120 and 122 provide additional thermal insulation to the battery cell thermal insulator 50A.

The various layers of the battery cell thermal insulator 50A of FIG. 2 are exemplary. In some variations, the layers of IIC material foam 140 may be applied to a single metal plate 110. In other variations, one of the layers of Aerogel® 120 or 122 may be applied to the single metal plate 110, and the layer or IIC material foam 140 may be applied to the layer of Aerogel® 120 or 122.

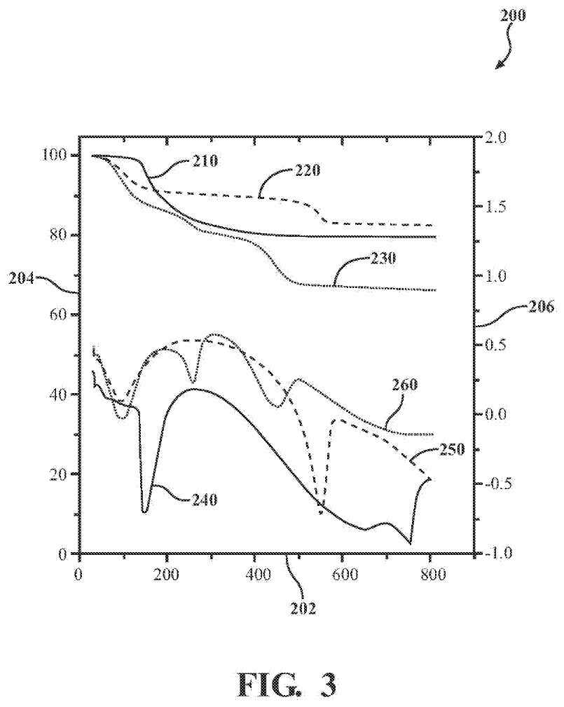

FIG. 3 is a graph 200 illustrating performance at high temperature of various materials that may be used to coat an outer surface of a battery cell thermal insulator 50A of FIG. 1. A horizontal axis 202 illustrates a temperature exposed to a surface of the battery cell thermal insulator 50A. A first vertical axis 204 illustrates by weight a presence of the coating material in the coating as compared to 100 total parts by weight of the coating. A second vertical axis 206 illustrates heat flow (in Wg\hat{ }−1). Plot 210 illustrates presence by weight loss of a geopolymer binder used with an IIC material at different temperatures. Plot 220 illustrates presence by weight loss of a Boehmite material at different temperatures. Plot 230 illustrates presence by weight loss of an MgCO₃ material at different temperatures. Plot 240 illustrates endothermal behavior of the geopolymer binder used with an IIC material. Plot 250 illustrates endothermal behavior of the Boehmite material. Plot 260 illustrates endothermal behavior of the MgCO₃ material. One can see three different materials all adsorb large amounts of heat during a thermal event. This ability to adsorb large amounts of heat may slow down heat transfer during the event. Plots 210, 220, and 230 demonstrate the mass loss of the IIC materials at different temperatures. This, combined with the information of plots 240, 250, and 260 which show phase transitions for the corresponding materials, may be used to assess the effectiveness of the IIC materials. The area of the peaks of plots 240, 250, and 260 are measures of an amount of heat that the materials can adsorb during the intumescent phase transition, while the plots 210, 220, and 230 show how much mass is lost during the intumescent phase transition.

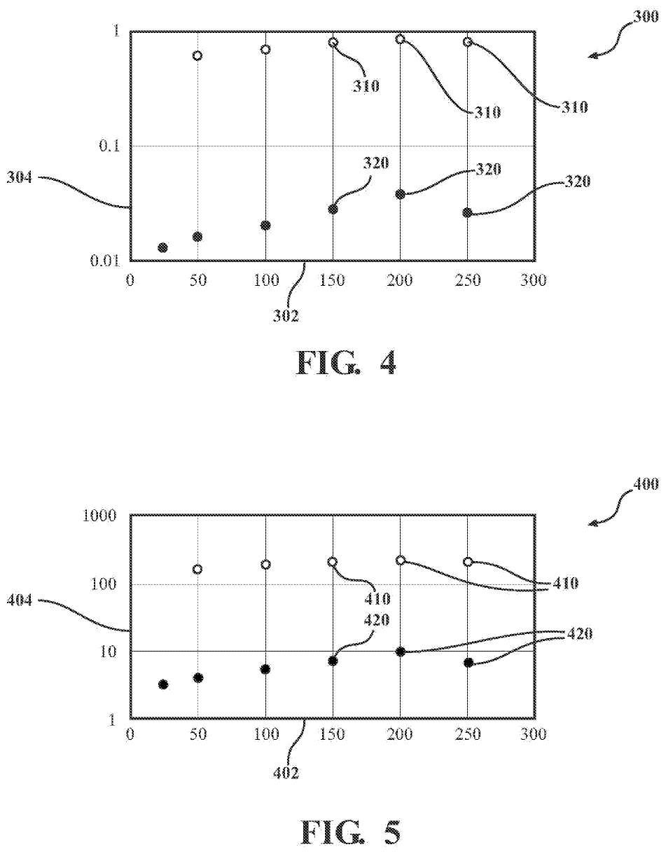

FIG. 4 is a graph 300 illustrating thermal diffusivity of a battery cell thermal insulator 50A of FIG. 1 coated with an IIC material versus a battery cell thermal insulator that is uncoated. A horizontal axis 302 illustrates a temperature exposed to a surface or the battery cell insulators. A vertical axis 304 illustrates thermal diffusivity in square millimeters per second with a logarithmic scale. Plot points 320 illustrate thermal diffusivity of the battery cell thermal insulator 50A including the IIC materials with a layer of 0.2 millimeter thick water glass. Plot points 310 illustrate thermal diffusivity of an uncoated metallic plate. One may see a large difference between plot points 310 and plot points 320, with the coated battery cell thermal insulator 50A being significantly better at diffusing heat energy.

FIG. 5 is a graph 400 illustrating thermal conductivity of a battery cell thermal insulator 50A of FIG. 1 coated with an IIC material versus a battery cell thermal insulator that is uncoated. A horizontal axis 402 illustrates a temperature exposed to a surface or the battery cell insulators. A vertical axis 404 illustrates thermal conductivity in Watts per meter Kelvin with a logarithmic scale. Plot points 410 illustrate thermal conductivity of an uncoated metallic plate. Plot points 420 illustrate thermal conductivity of the battery cell thermal insulator 50A including the IIC materials with a layer of 0.2 millimeter thick water glass. One may see a large difference between plot points 410 and plot points 420, with the uncoated metallic sheet being far more thermally conductive than the battery cell thermal insulator 50A.

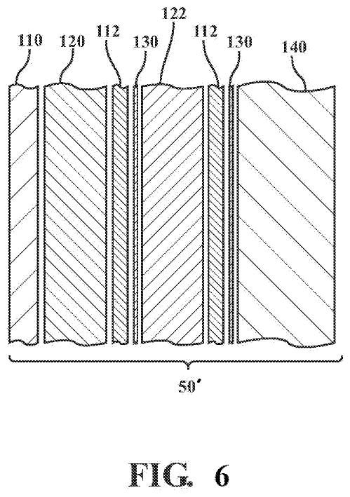

FIG. 6 schematically illustrates a battery cell thermal insulator 50′, which includes a coating including ICC material on one side of the battery cell thermal insulator 50′. The battery cell thermal insulator 50′ is similar to the battery cell thermal insulator 50A of FIG. 2, except that the battery cell thermal insulator 50′ is configured to resist high temperatures from a single direction. In one embodiment, the battery cell thermal insulator 50′ could be utilized to prevent heat transfer from a left side of the battery cell 10A to non-battery cell components to the left of the battery cell 10A. A relatively thick metal plate 110 and two relatively thin metal plates 112 are illustrated. The metal plates may be constructed with aluminum, steel, or other similar materials. In one embodiment, thicknesses of the aluminum plates may include a thickness from 0.200 millimeters to 0.300 millimeters. In another embodiment, thicknesses of the aluminum plates may include a thickness from 0.2 millimeters to 1 millimeter. In another embodiment, thickness of the steel plates may include 0.254 millimeters (the relatively thick metal plate 110) and 0.127 millimeters (the four relatively thin metal plates 112). Additionally, a layer of ATB 1000 Aerogel® 120 and a layer of ATB 2000 Aerogel® 122 are illustrated. The layer of ATB 1000 Aerogel® 120 is illustrated disposed between the relatively thick metal plate 110 and a first of the relatively thin metal plates 112. The layers of ATB 2000 Aerogel® 122 illustrated disposed between the first two relatively thin metal plates 112 and the remaining relatively thin metal plate 112. Additionally, two layers of polyester film 130 (PET film) are illustrated disposed next to each of the relatively thin metal plates 112. Finally, on the outside surface of the battery cell thermal insulator 50A, a layer of IIC material foam 140 including a geopolymer binder is illustrated.

While the best modes for carrying out the disclosure have been described in detail, those familiar with the art to which this disclosure relates will recognize various alternative designs and embodiments for practicing the disclosure within the scope of the appended claims.

What is claimed is:

1. A battery cell thermal insulator configured for mitigating a thermal event in a battery, the battery cell thermal insulator comprising:
a metal plate configured for providing rigidity to the battery cell thermal insulator; and
a layer of inorganic intumescent composite material disposed upon one side of the metal plate and configured for providing thermal resistivity.

2. The battery cell thermal insulator of claim 1, wherein the metal plate includes an aluminum sheet.

3. The battery cell thermal insulator of claim 1, wherein the metal plate includes a steel sheet.

4. The battery cell thermal insulator of claim 1, wherein the layer of inorganic intumescent composite material includes an inorganic thermal retardant selected from the group consisting of boehmite, MgCo₃, KNO₃, (NH₄)₃Po₄, and combinations thereof.

5. The battery cell thermal insulator of claim 1, wherein the layer of inorganic intumescent composite material includes an inorganic binder material selected from the group consisting of a geopolymer material and a water glass material.

6. The battery cell thermal insulator of claim 1, further comprising a thermal insulating foam disposed between and in contact with the metal plate and the layer of inorganic intumescent composite material.

7. A battery cell thermal insulator configured for mitigating a thermal event in a battery, the battery cell thermal insulator comprising:
a plurality of metal plates each configured for providing rigidity to the battery cell thermal insulator, wherein each of the plurality of metal plates is arranged parallel to another one of the plurality of metal plates;
at least one layer of thermal insulating foam disposed between and in contact with two of the plurality of metal plates; and
a layer of inorganic intumescent composite material disposed upon one side of an outermost one of the plurality of metal plates, wherein the layer of inorganic intumescent composite material is exposed on an outer surface of the battery cell thermal insulator and is configured for providing thermal resistivity.

8. The battery cell thermal insulator of claim 7, further comprising a second layer of inorganic intumescent composite material disposed upon one side of a second outermost one of the plurality of metal plates, wherein the layer of inorganic intumescent composite material is exposed on a second outer surface of the battery cell thermal insulator.

9. The battery cell thermal insulator of claim 7, wherein each of the plurality of metal plates is an aluminum sheet.

10. The battery cell thermal insulator of claim 7, wherein each of the plurality of metal plates is a steel sheet.

11. The battery cell thermal insulator of claim 7, wherein the layer of inorganic intumescent composite material includes an inorganic binder material.

12. The battery cell thermal insulator of claim 11, wherein the inorganic binder material is selected from the group consisting of a geopolymer material and a water glass material.

13. The battery cell thermal insulator of claim 7, further comprising a layer of polyester film disposed between and in contact with the layer of inorganic intumescent material and the outermost one of the plurality of metal plates.

14. A battery system comprising:
a first battery cell;
a second battery cell; and
a battery cell thermal insulator configured for mitigating a thermal event in the battery system, wherein the battery cell thermal insulator is disposed between the first battery cell and the second battery cell and includes:
at least one metal plate configured for providing rigidity to the battery cell thermal insulator;
a first layer of inorganic intumescent composite material disposed upon one side of the battery cell thermal insulator and configured for providing thermal resistivity; and
a second layer of inorganic intumescent composite material disposed upon a second side of the battery cell thermal insulator and configured for providing thermal resistivity.

15. The battery system of claim 14, further comprising:
a bus bar disposed adjacent to and in contact with the first battery cell; and
a third layer of inorganic intumescent composite material disposed on the bus bar and configured for preventing arcing between the first battery cell and the bus bar during the thermal event.

16. The battery system of claim 14, wherein the battery cell thermal insulator further includes:
a plurality of metal plates each arranged parallel to one another; and
a layer of thermal insulating foam disposed between and in contact with two of the plurality of metal plates.

17. The battery system of claim 14, further comprising:
a third battery cell; and
a second battery cell thermal insulator disposed between and in contact with the second battery cell and the third battery cell.

18. The battery system of claim 14, wherein the at least one metal plate is an aluminum sheet.

19. The battery system of claim 14, wherein the at least one metal plate is a steel sheet.

20. The battery system of claim 14, wherein the first layer of inorganic intumescent composite material includes an inorganic binder material.
